(19) United States
(12) Patent Application Publication
(10) Pub. No.: US 2005/0166794 A1
(43) Pub. Date: Aug. 4, 2005

(54) Binder additive for inkjet ink

(76) Inventor: Richard Douglas Bauer, Kennett Square, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/048,135

(22) Filed: Feb. 1, 2005

Related U.S. Application Data
(60) Provisional application No. 60/541,585, filed on Feb. 4, 2004.

(51) Int. Cl. C09D 11/14; B41J 2/01

(52) U.S. Cl. 106/31.37; 106/31.69; 347/100

(57) ABSTRACT

This invention pertains to an inkjet ink and, more particularly, to an inkjet ink comprising, as a binder additive, a dispersed cellulose ester. The binder additive enhances the durability of the printed image.

### CROSS-REFERENCE TO RELATED APPLICATION

This application claims priority under 35 U.S.C. §119 from U.S. Provisional Application Ser. No. 60/541,585 (filed Feb. 4, 2004), the disclosure of which is incorporated by reference herein for all purposes as if fully set forth.

### BACKGROUND OF THE INVENTION

This invention pertains to an inkjet ink and more particularly to an inkjet ink comprising, as a binder additive, a dispersed cellulose ester. The binder additive enhances the durability of the printed image.

Inkjet printing is a non-impact printing process in which droplets of ink are deposited on print media, such as paper, to form the desired image. The droplets are ejected from a printhead in response to electrical signals generated by a microprocessor. Inks used in such recording are subject to rigorous demands including, for example, good dispersion stability, ejection stability, and good fixation to media.

Inkjet printers offer low cost, high quality printing and have become a popular alternative to other types of printers such as laser printers. However, inkjet printers are presently unable to match the speed of laser printers and the durability of the laser printed images.

There is a need for inkjet inks that provide physically durable inkjet images.

### SUMMARY OF THE INVENTION

In one aspect, the present invention pertains to an inkjet ink comprising an aqueous vehicle and a dispersed cellulose ester binder additive. This inkjet ink may be substantially colorless, or may be colored by further comprising a colorant.

The dispersed cellulose ester binder additive will generally be present in the range of from about 0.5 to about 25 percent by weight, based on the total weight of the ink.

Preferably, the level of ester functionality in the cellulose ester binder additive, expressed as a degree of substitution per anhydroglucose unit, is at least about 1.4 (to 3.0), and more preferably from about 1.5 to about 2.9. Preferred ester functionality is selected from acetate, propionate, butyrate and any combination thereof.

In another aspect of the present invention, there is provided an ink set comprising at least three differently colored inks (such as CMY), and preferably at least four differently colored inks (such as CMYK), wherein:
at least one of the colored inks is an aqueous inkjet ink comprising an aqueous vehicle, a colorant and a dispersed cellulose ester binder additive; and/or
the ink set further comprises a colorless ink comprising an aqueous vehicle and a dispersed cellulose ester binder additive.

In yet another aspect of the present invention, there is provided a method for ink jet printing onto a substrate, comprising the steps of:
(a) providing an ink jet printer that is responsive to digital data signals;
(b) loading the printer with a substrate to be printed;
(c) loading the printer with an ink as set forth above and described in further detail below, or an ink jet ink set as set forth above and described in further detail below; and
(d) printing onto the substrate using the ink or inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Cellulose Esters and Dispersions Thereof

Cellulose esters and their manufacture are discussed in Kirk-Othmer “Encyclopedia of Chemical Technology,” Vol.5, Pages 496-529, 4^{th} ed., 1993. Another useful reference is Saunder, K. J., Organic Polymer Chemistry, Chapman and Hall, London, 1973 (pages 259-266). The relevant portions of these publications are incorporated by reference herein for all purposes as if fully set forth.

Cellulose is a polymer of anhydroglucose units. There are three hydroxyls per anhydroglucose unit in the cellulose background; each of the hydroxyls can be esterified or otherwise substituted. The degree of substitution is a number between 0 and 3, which refers to the average number of hydroxyls per anhydroglucose unit substituted with ester or other substitutent. Thus, when fully (100%) substituted, the degree of substitution (DS) is 3, when 50% substituted the DS is 1.5, and so forth.

The cellulose esters used in this invention are formulated, or further derivatized, to be dispersible in an aqueous vehicle, and are further preferably film forming (e.g., they form films at room temperature or with heat). Film formation will preferably occur at temperatures less than about 200° C., and more preferably less than about 140° C. The molecular weight of the cellulose ester is preferably at least about 2000 and less than about 200,000, and more preferably in the range of from about 5000 to about 100,000. Unless otherwise indicated, all molecular weight references are to number average molecular weight (Mn).

Cellulose esters and mixed esters can be prepared by complete acylation of the cellulose with anhydrides of the desired ester residues. For example, a mixture of acetic anhydride and butyric anhydride, in the presence of sulfuric acid as catalyst, can provide a cellulose acetate butyrate. The product is generally then hydrolyzed slightly to give a product with some small level of hydroxyl content, which tends to improve end use properties. The acetyl, butyryl and hydroxyl content of typical commercial grades of cellulose acetate butryate is summarized below.

| | As Weight Percent of Polymer | | | As Degree of Substitution | | |
|---|---|---|---|---|---|---|
| | Acetyl | Butyryl | Hydroxyl | Acetate | Butyrate | Hydroxy |
| (A) | 29.5 | 17 | 1 | 2.1 | 0.7 | 0.2 |
| (B) | 20.5 | 26 | 2.5 | 1.4 | 1.1 | 0.5 |
| (C) | 13 | 37 | 2 | 0.95 | 1.65 | 0.4 |
| (D) | 6 | 48 | 1 | 0.5 | 2.3 | 0.2 |

Generally, an increase in the butyryl content increases flexibility, moisture resistance, solubility and compatibility with other resins. The presence of hydroxyl groups can improve the stability of aqueous cellulose ester dispersions stabilized with amine-neutralized acrylic dispersants, and also provide sites for cross-linking by hydroxy-reactive crosslinkers such as melamine-formaldehyde, isocyanate and/or epoxy crosslinkers, examples of which are generally well known to those of ordinary skill in the art.

The degree of substitution (per anhydroglucose unit) of ester functionality is preferably at least about 1.4 (the maximum being 3), and usually in the range of from about 1.5 to about 2.9. The ester can be any ester, but most typically will be C2 (acetate), C3 (propionate) and/or C4 (butyrate) ester, and any combination thereof.

Cellulose esters are not aqueous soluble or dispersible on their own, and require further functionality (internal and/or external) to provide stability. Several methods for preparing cellulose ester dispersions are described herein below.

Preparation of Cellulose Ester Dispersion with Internal Stabilizer

One method to impart dispersion stability is to incorporate ionizable groups on the cellulose backbone (internal stabilization).

The ionizable group can be anionic, for example, a carboxyl group that is partially or fully neutralized. Carboxylated cellulose esters can be prepared in a number of ways. One way starts with carbomethoxy cellulose and involves esterifying free hydroxyl groups with, for example, acetate, butryate or propionate groups, and mixtures thereof. A second way starts with a cellulose acetate butryate or cellulose acetate propionate ester and forms acid groups by means of ozonation. A third way starts with a cellulose ester and involves treatment of the free hydroxyls with an anhydride of a dicarboxylic acid. An aqueous dispersion can be formed by dissolving the cellulose ester derivative in an organic solvent, neutralized as needed, and inverting the solution into water.

The ionic group can also be cationic, for example, the reaction products of cellulose esters with free hydroxyls and dimethylaminophenyl isocyanate to yield a polymer having pendant tertiary amine groups. The pendent amines can be quaternized with benzyl chloride or dimethyl sulfate, and the polymer inverted into water to yield a cationic dispersion of cellulose ester.

U.S. Pat. No. 5,668,273 and U.S. Pat. No. 5,994,530 (the disclosures of which are incorporated by reference herein for all purposes as if fully set forth) describe the preparation of carboxymethyl cellulose esters and aqueous compositions containing them. These are ether-ester derivatives of cellulose that combine a carboxymethyl substituent and propionyl, acetyl/propionyl, butyryl, or acetyl/butyryl substituents. These carboxymethyl cellulose esters are readily dispersed in waterborne formulations by means of neutralization with ammonia or amines. A commercial example of carboxymethylated cellulose acetate butryate is CMCAB-641-0.5 (Eastman Chemical) from which a waterborne dispersion can be readily prepared. This is a preferred material for use in the present invention. Some waterborne formulations are described in Eastman Publication GN-431 (see http://www.eastman.com/Online_Publications/GN431/index.htm) (the disclosure of which is incorporated by reference herein for all purposes as if fully set forth).

U.S. Pat. No. 5,521,292 (the disclosure of which is incorporated by reference herein for all purposes as if fully set forth) describes an aqueous dispersion comprising a cellulose ester with neutralizable carboxymethyl groups (D.S.≦0.2), nitrate groups bound directly to the backbone (D.S.≧0.4), and free hydroxyl groups.

U.S. Pat. No. 5,384,163 (the disclosure of which is incorporated by reference herein for all purposes as if fully set forth) discloses the preparation of carboxylated mixed cellulose esters by the reaction of free hydroxyl groups on the polymer with an anhydride of a dicarboxylic acid. Examples of useful diacids include succinic, phthalic and maleic. Waterborne dispersion can then be made by neutralization and inversion from organic solvent into water. A commercial example is cellulose acetate butryate succinate (Eastman Chemical Co.), formed by the reaction of cellulose acetate butyrate having a hydroxyl functionality with succinic anhydride.

U.S. Pat. No. 4,590,265 (the disclosure of which is incorporated by reference herein for all purposes as if fully set forth) describes the process of ozonation of mixed cellulose esters, e.g., those with propionyl, acetyl/propionyl, butyryl, or acetyl/butyryl substituents, to give polymers with carboxylate functionality. Waterborne dispersions can then be made by neutralization and inversion from organic solvent into water.

Preparation of Cellulose Ester Dispersion with Grafted Polymer Stabilizer

Another way to make a cellulose ester dispersion is by modifying the mixed cellulose ester with a stabilizing polymer (grafted polymer). The grafted polymer is formed in the presence of the cellulose ester and “grafts” thereon. The grafted polymer may in some case be chemically attached to cellulose, or in other cases just intimately mixed.

A cellulose ester dispersion can be prepared, for example, by starting with a solution of the cellulose ester in an organic solvent, then adding and polymerizing acrylic monomers containing acrylic and/or methacrylic acid in situ, followed by neutralization and inversion into water. The starting cellulose ester can contain an unsaturated maleic or fumaric acid residue bonded to it to enhance the grafting. Alternatively, a solution of cellulose ester and acrylic monomers in a water miscible organic solvent can be first inverted into water followed by polymerization.

U.S. Pat. No. 4,443,589 (the disclosure of which is incorporated by reference herein for all purposes as if fully set forth) describes the preparation of a graft copolymer of at least one acrylic monomer and a cellulose ester wherein at least 8% of the total weight of the graft copolymer is derived from acrylic acid, methacrylic acid or both. The grafting is done in an organic solution of the mixed ester and the acrylic monomers, after which the graft copolymer solution is neutralized with base and inverted into waterborne dispersion.

WO8505112 (the disclosure of which is incorporated by reference herein for all purposes as if fully set forth) discloses a process for making carboxylated acrylate or acrylate/vinyl monomer grafted mixed cellulose esters from the ozonized mixed cellulose ester described in previously incorporated U.S. Pat. No. 4,590,265. The acrylate grafts are polymerized from the existing peroxide functionality on the ozonized mixed cellulose ester.

U.S. Pat. No. 4,758,645 and U.S. Pat. No. 4,714,634 (the disclosures of which are incorporated by reference herein for all purposes as if fully set forth) disclose another process for preparing cellulose esters grafted with vinyl and/or acrylic polymers. The monomers in these polymers are grafted to maleic or fumaric ester unsaturation appended to the cellulose ester backbone. The polymers can be prepared with sufficient acid monomers incorporated into the polymer graft so as to be readily made into a waterborne dispersion by neutralization and inversion into water.

U.S. Pat. No. 4,435,531 (the disclosure of which is incorporated by reference herein for all purposes as if fully set forth) discloses a cellulose containing emulsion composition prepared by first grafting onto a cellulose derivative an ethylenically unsaturated monomer component comprising an ethylenically unsaturated acid and at least one other ethylenically unsaturated monomer to prepare a vinyl polymer modified cellulose derivative with an acid number of from 1 to 150; adding additional ethylenically unsaturated monomer and amine to the mixture; dispersing the mixture in water; and then emulsion polymerizing the residual monomer. The cellulose derivative is an ester or ether modified derivative having a number average molecular weight from 3000 to 300,000. The ester modified cellulose derivatives are preferably selected from nitrocellulose, cellulose acetate butyrate, cellulose acetate propionate, cellulose acetate phthalate, acetylcellulose, cellulose propionate, cellulose butryate, cellulose sulfate and cellulose phosphate. The ether-modified cellulose derivatives are preferably selected from methyl cellulose, ethyl cellulose, butyl cellulose, benzyl cellulose, carboxy methyl cellulose, carboxy ethyl cellulose, aminoethyl cellulose, hydroxy ethyl cellulose, oxyethyl cellulose, hydroxypropyl cellulose and hydroxypropyl methyl cellulose.

U.S. Pat. No. 3,953,386 and U.S. Pat. No. 4,011,388 (the disclosures of which are incorporated by reference herein for all purposes as if fully set forth) disclose the preparation of an aqueous polymer emulsion with a dispersed phase comprising a homogeneous blend of a water insoluble cellulosic ester (e.g., cellulose nitrate or cellulose acetate butryate) and an acrylic polymer. The product is formed by dissolving the cellulose in the monomer, dispersing the mixture in an aqueous surfactant system, and polymerizing the monomer in the dispersed phase.

U.S. Pat. No. 4,252,697 (the disclosure of which is incorporated by reference herein for all purposes as if fully set forth) discloses the preparation an aqueous dispersion of resin particles containing cellulose acetate butyrate or cellulose acetate propionate dissolved or homogeneously dispersed therein prepared by dissolving the cellulose ester and an oil-soluble radical polymerization initiator in one or a mixture of radically-polymerizable water-insoluble monomers capable of dissolving the cellulose ester, mixing this with a protective colloid or surfactant, forming a dispersion of particles, and subjecting the dispersion of particles to radical polymerization.

Any or all preparations described above for grafted cellulose esters can use a vinyl monomer like dimethylamino(meth)acrylate as all or part of the monomer mixture during the preparation of the grafted ester. The intermediate composite polymer can then be quaternized and inverted into water to give a cationic dispersion.

Preparation of Cellulose Ester Dispersion with Polymer Dispersant Stabilizer

Yet another way to make a cellulose ester dispersion is to dissolve a preformed dispersant, such as an acrylic polymer dispersant (external stabilizer), with a cellulose ester polymer in an organic solvent and invert the mixture into water. Combinations of internal and external stabilization may also be utilized.

U.S. Pat. No. 5,334,638 and U.S. Pat. No. 5,418,014 (the disclosures of which are incorporated by reference herein for all purposes as if fully set forth) disclose the preparation of an aqueous dispersion of a cellulose ester, organic solvent, water, and acrylic resin having free acid functionalities that are at least partially neutralized. A non-carboxylated cellulose ester with at least 6 to 9 unit molecular weight percent of hydroxyl groups was reported to give optimum dispersion stability.

U.S. Pat. No. 5,286,768 (the disclosure of which is incorporated by reference herein for all purposes as if fully set forth) discloses an aqueous coating composition containing an amine-neutralized arylic resin dispersant and a mixed ester of cellulose that has been reacted with the anhydride of a dicarboxylic acid, such as succinic acid.

U.S. Pat. No. 5,384,163 (the disclosure of which is incorporated by reference herein for all purposes as if fully set forth) discloses the preparation of an aqueous dispersion in which the particles are comprised of a cellulose ester polymer and a polyurethane polymer.

Particularly preferred as polymer dispersant stabilizer are structured polymers, especially acrylic block copolymers and SCT graft acrylic copolymers, particularly those that are typically used in aqueous inkjet inks. Also preferred is neutralization of these acrylic polymers with amine. Cationic or quaternary block or SCT graft copolymers can also used to provide a cationic polymer dispersant-stabilized cellulose ester dispersion.

Preparation of Cellulose Ester Dispersion Having Cross-Linkable Functions

The cellulose ester dispersions described above can be fully or partially crosslinked prior to use in ink, and/or the inks may can contain crosslinking agents such as amino-plasts, epoxies, blocked isocyanates and the like, that can be cross-linked after printing.

U.S. Pat. No. 5,420,267 (the disclosure of which is incorporated by reference herein for all purposes as if fully set forth), for example, discloses the preparation of water-dispersible cellulose acetoacetate copolymers. The acetoacetate functionality can be cross-linked by enamine formation with multifunctional amines, or by Michael addition with multifunctional acrylates.

U.S. Pat. No. 4,134,809 (the disclosure of which is incorporated by reference herein for all purposes as if fully set forth) discloses cellulose esters that have been reacted with dicarboxylic anhydrides, followed by reaction of the carboxylate group with glycidyl (meth)acrylate. This produces a cellulose ester with acrylic unsaturation that is readily cross-linkable by UV radiation.

U.S. Pat. No. 4,490,516 (the disclosure of which is incorporated by reference herein for all purposes as if fully set forth) discloses acrylamidomethyl derivatized (degree of substitution of about 0.05 to about 0.5) cellulose esters prepared by reacting a cellulose ester or ether containing free hydroxyl groups with an acrylamide reactant containing a methylol group. The product is capable of homopolymerization or co-polymerization with other vinyl monomers, or it can be cross-linked by UV irradiation. Such polymers are commercially available under the trade designation Jaylink® from Bomar Specialties Co. (Winsted, Conn.). Reaction of a self-dispersible or grafted cellulose ester containing free hydroxyls with an acrylamide reactant containing a methylol group can produce a self-dispersible cross-linkable cellulose ester dispersion.

U.S. Pat. No. 4,839,230 (the disclosure of which is incorporated by reference herein for all purposes as if fully set forth) discloses cellulose esters grafted with acrylic anhydride or m-isopropenyl-alpha,alpha′-dimethylbenzene isocyanate to provide unsaturated cross-linking sites.

U.S. Pat. No. 5,082,914 (the disclosure of which is incorporated by reference herein for all purposes as if fully set forth) discloses cellulose esters that have been reacted with silyl ethers containing thiol groups. These groups render the cellulose esters capable of crosslinking with species containing vinyl and acrylic unsaturation in the presence of radical initiators or UV initiators.

Inks

As indicated above, the inks in accordance with the invention comprise an aqueous vehicle and a dispersed cellulose ester binder additive. This inkjet ink may be substantially colorless, or may be colored by further comprising a colorant.

Vehicle

The vehicle is preferably an “aqueous vehicle” by which is meant water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

Inks based on aqueous vehicles can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

Colored Inks

Colored inks comprise colorant in addition to vehicle and dispersed cellulose ester binder additive. The colorants can be soluble (dye) or dispersed (pigment) in the ink vehicle.

Conventional dyes such as anionic, cationic, amphoteric and non-ionic dyes are useful in this invention. Such dyes are well known to those of ordinary skill in the art. Anionic dyes are those dyes that, in aqueous solution, yield colored anions. Cationic dyes are those dyes that, in aqueous solution, yield colored cations. Typically anionic dyes contain carboxylic or sulfonic acid groups as the ionic moiety. Cationic dyes usually contain quaternary nitrogen groups.

The types of anionic dyes most useful in this invention are, for example, Acid, Direct, Food, Mordant and Reactive dyes. Anionic dyes are selected from the group consisting of nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

The types of cationic dyes that are most useful in this invention include mainly the basic dyes and some of the mordant dyes that are designed to bind acidic sites on a substrate, such as fibers. Useful types of such dyes include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds, and thiazine compounds, among others, all of which are well known to those skilled in the art.

Useful dyes include (cyan) Acid Blue 9 and Direct Blue 199; (magenta) Acid Red 52, Reactive Red 180, Acid Red 37, Cl Reactive Red 23; and (yellow) Direct Yellow 86, Direct Yellow 132 and Acid Yellow 23. The black colorant may also be dye as, for example, the black dye disclosed in U.S. Pat. No. 5,753,016 (the disclosure of which is incorporated by reference herein for all purposes as if fully set forth).

Pigments, traditionally, are stabilized to dispersion in a vehicle by dispersing agents, such as polymeric dispersants or surfactants. More recently though, so-called “self-dispersible” or “self-dispersing” pigments (hereafter “SDP”) have been developed. As the name would imply, SDPs are dispersible in water, or aqueous vehicle, without dispersants. The black pigment may be stabilized to dispersion by surface treatment to be self-dispersing (see, for example, WO01/94476, the disclosure of which is incorporated by reference herein for all purposes as if fully set forth), by treatment with dispersant in the traditional way, or by some combination of surface treatment and dispersant.

Preferably, when dispersant is employed, the dispersant(s) is a random or structured polymeric dispersant. Preferred random polymers include acrylic polymer and styrene-acrylic polymers. Most preferred are structured dispersants which include AB, BAB and ABC block copolymers, branched polymers and graft polymers. Some useful structured polymers are disclosed in U.S. Pat. No. 5,085,698, EP-A-0556649 and U.S. Pat. No. 5,231,131 (the disclosures of which are incorporated by reference herein for all purposes as if fully set forth).

Useful pigment particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

Useful pigments include (cyan) Pigment Blue 15:3 and 15:4; (magenta) Pigment Red 122; (yellow) Pigment Yellow 128, Pigment Yellow 95, Pigment Yellow 155 and Pigment Yellow 74; and (black) carbon black.

Other Ingredients

Other ingredients may be formulated into the inkjet ink, to the extent that such other ingredients do not interfere with the stability and jetablity of the ink, which may be readily determined by routine experimentation. Such other ingredients are in a general sense well known in the art.

Polymer additives, other than cellulose esters, may also be added to the ink. The polymers can be soluble in the vehicle or dispersed (e.g. “emulsion polymer” or “latex”), and can be ionic or nonionic. Useful classes of polymers include acrylics, styrene-acrylics and polyurethanes.

Plasticizers or coalescing aids may be added to enhance film formation and/or flexibility of the cellulose esters and other polymer additives. Also UV inhibitors may be useful.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Ink Properties

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower, more typically in the range of about 1 to about 20 cps. The ink has physical properties that are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic. The inks are particularly suited for drop on demand inkjet printheads, especially thermal and piezo printheads.

Proportions of Ingredients

The components described herein can be combined in various proportions and combinations to make an ink with the desired ink properties, as generally described above, and as otherwise generally recognized by those of ordinary skill in the art. Some experimentation may be necessary to optimize inks for a particular end use, but such optimization is generally within the ordinary skill in the art.

For example, the amount of vehicle in an ink is typically in the range of about 70% to about 99.8%, and preferably about 80% to about 99.8%, by weight based on total weight of the ink.

The dispersed cellulose ester binder (internally stabilized and/or in combination with external stabilizers) typically will be present at levels of at least about 0.5% up to about 25%, and more typically in the range of about 1% to about 20%, by weight (solids) based on the total weight of ink.

In a colored ink, colorant will generally be present in amounts up to about 12%, and more typically in the range of about 0.1 to about 9%, by weight of the total ink. Dispersants, when needed for stabilization of an insoluble colorant, are employed at levels based on the amount of colorant and are usually expressed as a weight ratio. Generally, dispersants are employed at a pigment-to-dispersant weight ratio in the range of about 1:3 to about 4:1.

Other ingredients (additives), when present, generally comprise less than about 15% by weight, based on the total weight of the ink. Surfactants, when added, are generally in the range of about 0.2 to about 3% by weight based on the total weight of the ink. Polymers other than cellulose esters can be added as needed, but will generally be less than about 15% by weight based on the total weight of the ink.

Ink Sets

The ink sets in accordance with the present invention preferably comprise at least three differently colored inks (such as CMY), and preferably at least four differently colored inks (such as CMYK), wherein:
at least one of the colored inks is an aqueous inkjet ink comprising aqueous vehicle, a colorant and a dispersed cellulose ester binder additive; and/or
the ink set further comprises a substantially colorless ink comprising an aqueous vehicle and a dispersed cellulose ester binder additive.

The other inks of the ink set are preferably also aqueous inks, and may contain dyes, pigments or combinations thereof as the colorant. Such other inks are, in a general sense, well known to those of ordinary skill in the art.

In one preferred embodiment, the ink set comprises three differently colored inks as follows:
(a) a first colored ink comprising a first aqueous vehicle, a first colorant and a first dispersed cellulose ester binder additive;
(b) a second colored ink comprising a second aqueous vehicle, a second colorant and a second dispersed cellulose ester binder additive; and
(c) a third colored ink comprising a third aqueous vehicle, a third colorant and a third dispersed cellulose ester binder additive.

Preferably, the first colored ink is a cyan ink, the second colored ink is a magenta ink and the third colored ink is a yellow ink.

In another preferred embodiment, this ink set further comprises (d) a fourth colored ink comprising a fourth aqueous vehicle, a fourth colorant and a fourth dispersed cellulose ester binder additive. Preferably this fourth colored ink is a black ink.

In yet another preferred embodiment, this ink set (CMY and/or CMYK) further comprises a first colorless ink comprising a fifth aqueous vehicle and a fifth dispersed cellulose ester binder additive.

The ink set may further comprise one or more “gamut-expanding” inks, including different colored inks such as an orange ink, a green ink, a red ink and/or a blue ink, and combinations of full strength and light strengths inks such as light cyan and light magenta. These “gamut-expanding” inks are particularly useful in textile printing for simulating the color gamut of analog screen printing, such as disclosed in US20030128246 (the disclosure of which is incorporated by reference herein for all purposes as if fully set forth).

Methods of Printing

The inks and ink sets of the present invention can be utilized by printing with any inkjet printer.

A colorless ink, when utilized can be applied over the colored ink(s) as an overcoat to improve properties of the printed image, such as durability. The colorless ink can also be applied (concurrently or consecutively) in areas of the printed image not covered by the colored inks, for example, to substantially equalize gloss over the printed image, such as disclosed in US20030193553 (the disclosure of which is incorporated by reference herein for all purposes as if fully set forth).

Substrates

Substrates suitable for use in the present invention can be any useful substrate known to those of ordinary skill in the relevant art. For example, the substrate can be plain paper such as common electrophotographic copier paper. The substrate can also be specialty media such as microporous papers, polymer coated papers and hybids of the two. The substrate can be polymeric film such as vinyl chloride and polyester. Polymeric films are especially useful in wide-format applications such as signs, billboards and banners. The substrate can be a non-woven textile such as spun bonded polyolefin (e.g. Tyvek®, DuPont Co.). The substrate can also be woven textile such as silk, cotton, nylon and polyester.

This invention now will be further illustrated, but not limited, by the following examples.

### EXAMPLES

The starting cellulose ester was CMCAB-641-0.5 from Eastman Chemical Co., a carboxymethylated cellulose acetate butryate. The resin had an acid number of 60 (DS of carboxymethyl=0.37), a butyryl content of 39% (DS=1.91), an acetyl content of 7% (DS=0.51), a hydroxyl content of 1% (DS=0.21), and a molecular weight, Mn, of about 35,000.

Solvent Solution

Sixty grams of CMCAB-641-0.5 was dissolved in a mixture of 60 grams of Dowanol EB, 40 grams of isopropyl alcohol, and 40 grams of methylethyl ketone to give 200 grams polymer solvent solution. This was decanted from a small swollen plug of undissolved polymer to give a clear solvent solution (“CMCAB solution”) with 29.8 weight percent of solids.

Aqueous Dispersion

To a 50 gram portion of CMCAB solution was added 0.23 grams of dimethylamino ethanol, followed by addition of 49.8 grams of deionized water with slow agitation to give a white dispersion with a viscosity of 282 cps at 25° C., a pH of 4.72, and a particle size of 195 nm. This is referred to as “CMCAB dispersion”.

Aqueous Solution (Comparative)

An aqueous cellulose ester solution was made by mixing 50 grams of the CMCAB solution with 1.44 grams of dimethylamino ethanol (100% neutralization) with stirring, followed by addition of 48.6 grams of water to form a viscous (>2000 cps) aqueous polymer solution at 14.9% solids. Even upon dilution to 0.5% solids with the same ink vehicle used to make the test inks described below, the viscosity was still about 7 cps. Solutions of cellulose ester solutions provide undesirably high viscosity.

Pigment Dispersion

The colorant was Cab-O-Jet® 300 pigment dispersion used as received from the vendor, Cabot Corporation (aqueous dispersion with 15.1% self-dispersed carbon black pigment (carbon black surface-modified with grafted carboxylate groups)).

Test Inks

Two inks were prepared according to the formulas in the following table. Amounts are in percent weight of the total weight of ink.

| | Ink A | |
|---|---|---|
| Ingredients | (comparative) | Ink 1 |
| Pigment dispersion (as % solid) | 3% | 3% |
| Glycerol | 9% | 9% |
| Ethylene glycol | 6% | 6% |
| 1,2-hexanediol | 5% | 5% |
| BYK ® 348 (surfactant, Byk Chemie) | 0.10% | 0.10% |
| CMCAB dispersion (as % polymer solids) | | 4% |
| Water (balance to 100%) | balance | balance |
| Viscosity (30 rpm@25° C.), CPS | 2.2 | 9.5 |
| pH | 7.1 | 5.2 |

Print Test

The black pen of an Epson 3000 printer operating in the 1440 dpi mode was used to print test patterns ½ inch wide and 6 inches long onto Gilbert bond paper.

The test strip from each trial was cut into four equal parts and treated immediately after printing as follows:
(a) Air dry at ambient temperature.
(b) Oven dry at 120° C. for 10 minutes.
(c) Pass under a focused radiant heater at 8 feet per minute, whereupon the temperature of the printed area reaches about 250° C.
(d) Second pass under the focused radiant heater at 8 feet per minute.
   The type of post treatment for each strip is indicated by an “a”, “b”, “c”, or “d” in the table below.

Each strip was given a double strike with a basic hi-liter (Avery #240XX) and an acid hi-liter (Avery #0774X) at 10 minutes after printing and 24 hours after printing, and visually evaluated for smear according to the following scale:
5) very heavily smeared
4) heavily smeared
3) some smearing
2) slight amount of smearing
1) very slight amount of smearing

0) no smearing.

| | | |
|---|---|---|
| | Acid HiLiter | Alkalai HiLiter |
| Post | Smear Rating | Smear Rating |

| Ink | Treatment | 10 min | 24 hrs | 10 min | 24 hrs |
|---|---|---|---|---|---|
| Ink A | a | 5 | 5 | 5 | 4 |
| Ink 1 | a | 3 | 2 | 3 | 3 |
| Ink A | b | 5 | 5 | 5 | 5 |
| Ink 1 | b | 2 | 2 | 2 | 2 |
| Ink A | c | 5 | 5 | 5 | 5 |
| Ink 1 | c | 2 | 1 | 2 | 2 |
| Ink A | d | 4 | 4 | 4 | 4 |
| Ink 1 | d | 1 | 1 | 2 | 2 |

It is most desirable for an ink to show little or no smearing. The ink sample with the CMCAB dispersion (Ink 1) showed a significant reduction in the amount of smear, especially in the heated samples.

1. An inkjet ink comprising aqueous vehicle and a dispersed cellulose ester binder additive.

2. The inkjet ink of claim 1, wherein the cellulose ester binder additive has a level of ester functionality, expressed as a degree of substitution per anhydroglucose unit, of at least about 1.4

3. The inkjet ink of claim 1, wherein the cellulose ester binder additive has a level of ester functionality, expressed as a degree of substitution per anhydroglucose unit, in the range of about 1.5 to about 2.9.

4. The inkjet ink of claim 1, wherein the cellulose ester binder additive has a level of ester functionality, expressed as a degree of substitution per anhydroglucose unit, of at least about 1.4, and the ester functions are selected from acetate, propionate, butyrate, and any combination thereof.

5. The inkjet ink of claim 1, wherein the dispersed cellulose ester binder additive is present in the range of from about 0.5 to about 25 percent by weight, based on the total weight of the inkjet ink.

6. The inkjet ink of claim 1, wherein the dispersed cellulose ester binder additive is a C2 to C4 ester of a carboxy (C1-C3) alkyl cellulose having:
(a) a molecular weight of about 5000 to about 100,000,
(b) a degree of substitution per anhydroglucose unit of carboxy (C1 to C3) alkyl greater than about 0.2 to about 0.75, and
(c) a degree of substitution per anhydroglucose unit of C2 to C4 ester of about 1.50 to about 2.70,
wherein at least 25% of all free carboxyl groups in said C2-C4 ester of carboxy C1-C3 alkyl cellulose have been neutralized with ammonia or an amine.

7. The inkjet ink of claim 1, which is substantially colorless.

8. The inkjet ink of claim 1, further comprising a colorant.

9. The inkjet ink of claim 8, wherein the colorant comprises a pigment.

10. The inkjet ink of claim 8, wherein the colorant comprises a dye.

11. The inkjet ink of claim 1, wherein, at 25° C., the viscosity is in the range of about 1 and 20 cps and surface tension ins in the range of 20 to 70 dynes/cm.

12. An ink set comprising at least three differently colored inks, wherein at least one of the colored inks is an aqueous inkjet ink comprising an aqueous vehicle, a colorant and a dispersed cellulose ester binder additive.

13. The ink set of claim 12, comprising:
(a) a first colored ink comprising a first aqueous vehicle, a first colorant and a first dispersed cellulose ester binder additive;
(b) a second colored ink comprising a second aqueous vehicle, a second colorant and a second dispersed cellulose ester binder additive; and
(c) a third colored ink comprising a third aqueous vehicle, a third colorant and a third dispersed cellulose ester binder additive.

14. The ink set of claim 13, wherein the first colored ink is a cyan ink, the second colored ink is a magenta ink and the third colored ink is a yellow ink.

15. An ink set comprising at least three differently colored inks, and further comprising a colorless ink comprising an aqueous vehicle and a dispersed cellulose ester binder additive.

16. A method for ink jet printing onto a substrate, comprising the steps of:
(a) providing an ink jet printer that is responsive to digital data signals;
(b) loading the printer with a substrate to be printed;
(c) loading the printer with an inkjet ink comprising an aqueous vehicle and a dispersed cellulose ester binder additive; and
(d) printing onto the substrate using the inkjet ink in response to the digital data signals.

17. The method of claim 16, wherein the printer is loaded with an ink set comprising at least three differently colored inks, wherein at least one of the colored inks is an aqueous inkjet ink comprising an aqueous vehicle, a colorant and a dispersed cellulose ester binder additive; and the substrate is printed using the inkjet ink set.

18. The method of claim 17, wherein the ink set comprises:
(a) a first colored ink comprising a first aqueous vehicle, a first colorant and a first dispersed cellulose ester binder additive;
(b) a second colored ink comprising a second aqueous vehicle, a second colorant and a second dispersed cellulose ester binder additive; and
(c) a third colored ink comprising a third aqueous vehicle, a third colorant and a third dispersed cellulose ester binder additive.

19. The method of claim 18, wherein the first colored ink is a cyan ink, the second colored ink is a magenta ink and the third colored ink is a yellow ink.

20. The method of claim 16, wherein the printer is loaded with an ink set comprising at least three differently colored inks, and further comprising a colorless ink comprising an aqueous vehicle and a dispersed cellulose ester binder additive.
